(19) United States
(12) Patent Application Publication
(10) Pub. No.: US 2005/0030307 A1
(43) Pub. Date: Feb. 10, 2005

(54) Workflow method applicable in a workflow engine

(76) Inventor: Bernd Schneider, Baden Wurttemberg (DE)

Correspondence Address: Schneider Bernd, Haldenweg 41, Thringen, 79241, DE

(21) Appl. No.: 10/486,290

(22) PCT Filed: Jul. 26, 2001
(86) PCT No.: PCT/IB01/01337

(30) Foreign Application Priority Data
Jul. 26, 2001 (EP) PCT7EP02''''

(51) Int. Cl. G06T 1/00; G06F 17/00

(52) U.S. Cl. 345/418

(57) ABSTRACT

The Cognitive Process Workflow (CPW) method with its grammar, syntax and semantics is a workflow method applicable to different technical systems. The CPW Process is represented in the form of simple sentence with subject, predicate and object. According to the CPW definition the process in the conventional sense is a Predicate. From now on the conventional process (predicate) is consequently put in the context of responsibility (subject) and process result (object), thus forming a CPW Process. The CPW Method—with CPW Process, CPW Dialog and CPW Workflow as well as CPW Context Diagrams (CPW Subject Context Diagram, CPW Object Context Diagram and CPW Subject Object Context Diagram)—can be applied to business areas of financial services (banking, assurance and financial approval), chemistry, pharmacy, medicine, transport, travel, film industry, politics, psychology, legal practice and areas of CRM Customer Relationship Management, ERP Enterprise Resource Planning, SCM Supply Chain Management, E-Business Integration.

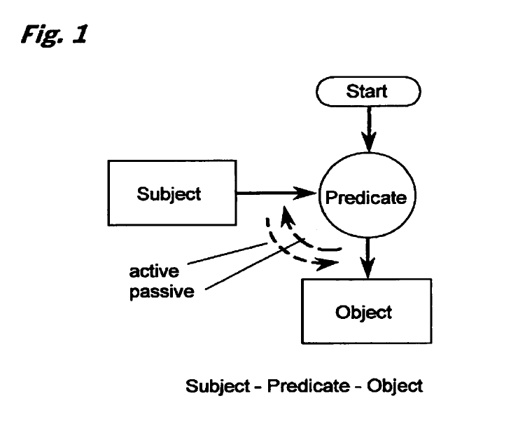

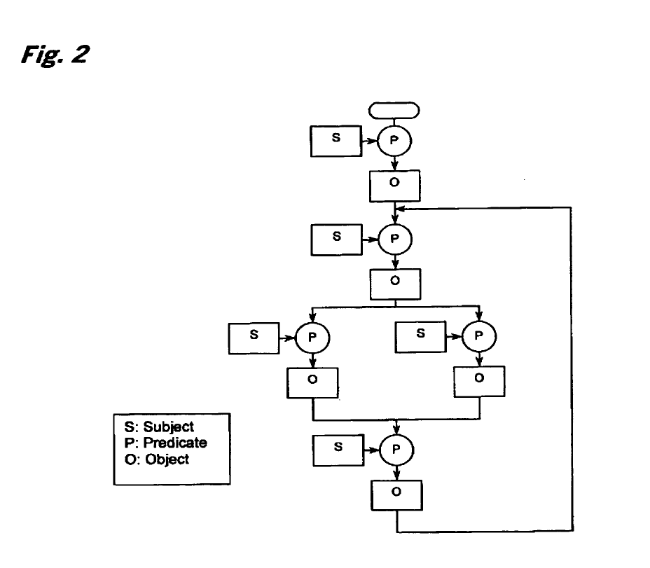

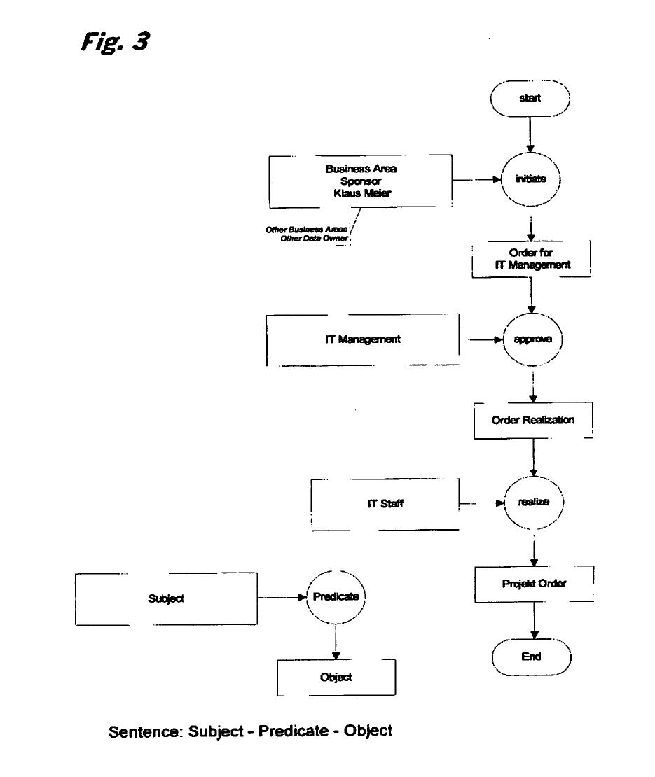

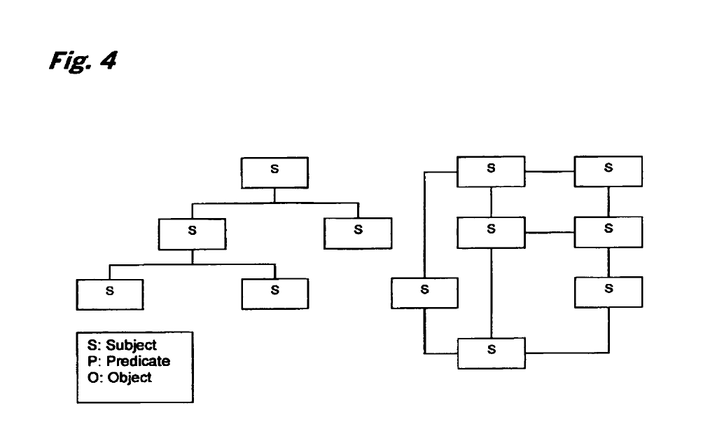

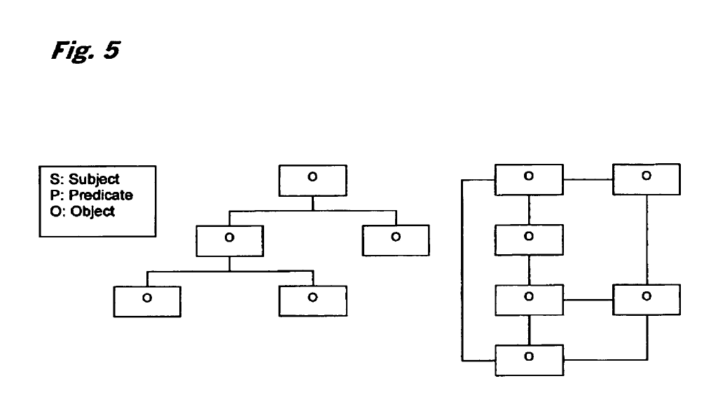

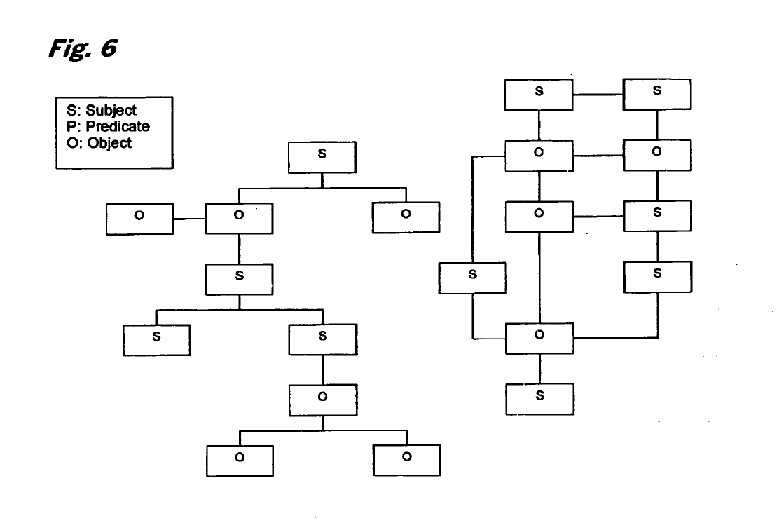

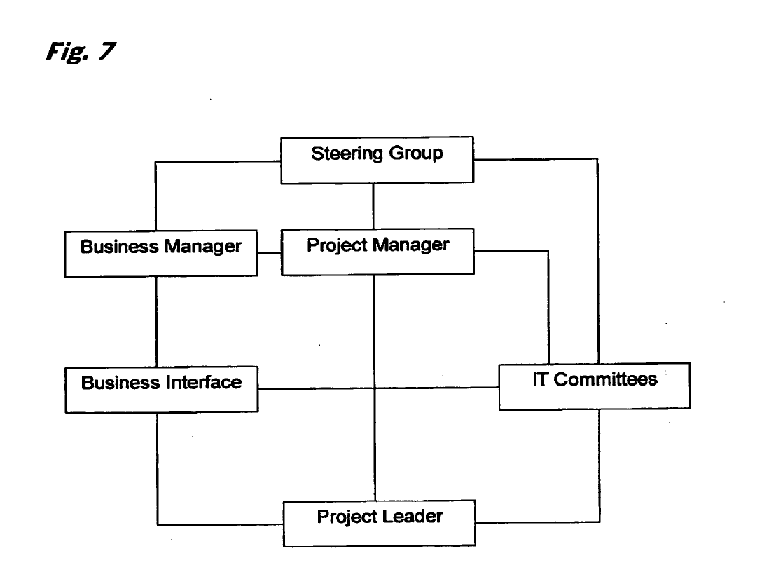

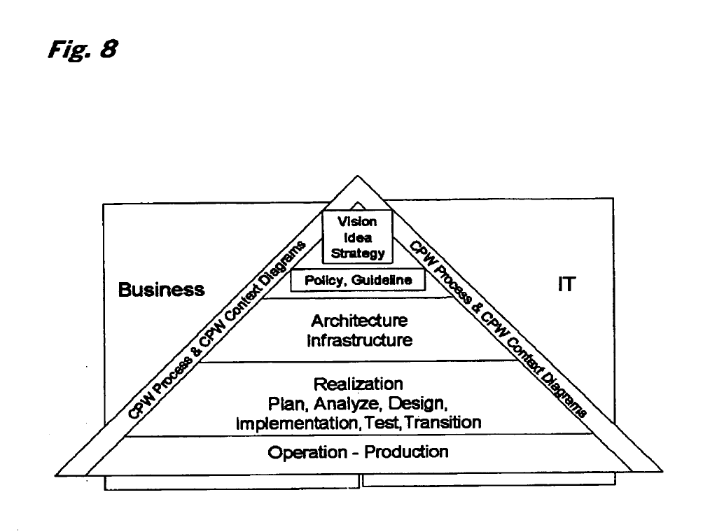

### 1. What is the Subject of the Requested Patent?

The patent's subject is a concept focusing on a workflow method. The method was created by Bernd Jakob Schneider and is called Cognitive Process Workflow (CPW) Method.

The requested patent covers the application of the CPW Method firstly in technical systems and secondly by means of Internet technologies.

The requested patent should—if possible13 include the CPW Method.

### 2. Cognitive Process Workflow (CPW) Method

The Cognitive Process Workflow (CPW) Method is subdivided into:
CPW Process
CPW Dialog
CPW Workflow
CPW Context Diagrams

The CPW Context Diagrams are subdivided into:
CPW Subject Context Diagram
CPW Object Context Diagram
CPW Subject Object Context Diagram

[image]

[image]

[image]

[image]

[image]

[image]

[symbol]

### 4. Central Administration of the CPW Data

### 4.1 Central Administration of the CPW Data by Means of VISIO

The CPW Processes respectively CPW Workflows of various business areas can be designed by means of the Mircrosoft Tool Visio and published as HTML File on the Web Server. Thus it is possible for the Web Server Administrator to administrate the Business Processes centrally and to publish them in the Intranet. When and how the CPW Processes gain validity, is communicated via e-mail.

### 4.2 Woriflow Engine

The Workflow engine is realized by means of Web Technology. The application is applicable for the Intranet and Internet. The CPW Data are administrated centrally.

The CPW Data are in a relational database on the web server. The Business Process Engineer administrates the CPW Data by means of the Web Client, which communicates with the Web Server. The web client is realized in XML and Jscript/ASP. According to the existing infrastructure and architecture within a company the following technical variants are possible in the realization:
HTML/XML with ASP (Active Server Page) on a web server with relational data base
Java Application/Applet with JDBC/ODBC Connection on a web server with relational database
HTML/XML with Servlets, which have the connectivity on the web server to the relational database
Corba Client/Server Technology with connection to a relational database

1. All kinds of applications of the Cognitive Process Workflow (CPW) Method—with the CPW Process, CPW Dialog and CPW Workflow as well as the CPW Context Diagrams (CPW Subject Context Diagram, CPW Object Context Diagram and CPW Subject Object Context Diagram)—in technical systems. There are namely:
(a) The application of the CPW Method in a Workflow Engine.
(b) The application of the graphical representation of the CPW Method in a technical system.
(c) The application of the CPW Method in an application system with integrated database.

2. All kinds of applications of the CPW Method by means of Internet technologies.

3. Grammar, syntax and semantics of the CPW Dialog and CPW Workflow, with which the CPW Processes are represented as simple sentences with subject, predicate and object.

4. According to the concept of the CPW Process the process in the conventional sense is formed as a predicate. From now on the conventional process (predicate) is consequently put in the context of a responsibility (subject) and a process result (object), thus forming a CPW Process.

5. The CPW Process in the form of a simple sentence with subject, predicate and object is represented graphically. Within a represented CPW Process respectively within a sentence the subject, predicate and object each corresponds with a graphic object. Subject, predicate and object—each represented as a single graphic object—are graphically linked to one another so that they form a Simple Sentence.

6. Grammar, syntax and semantics of the CPW Method—with the CPW Process, CPW Dialog and CPW Workflow as well as the CPW Context Diagrams (CPW Subject Context Diagram, CPW Object Context Diagram and CPW Subject Object Context Diagram)

7. The application of the CPW Method to data and information in various business areas, in particular:
(a) Financial Services (Banking, Assurance and Financial Approval)
(b) Chemistry
(c) Pharmacy
(d) Medicine
(e) Transport
(f) Travel
(g) Film Industry
(h) Politics
(i) Psychology
(j) Legal Practice, Jurisprudence, Judiciary
Thereby the application of the CPW Method can take place In a technical system according to claim 1 and claim 2.

8. The application of the CPW Method to data and information in the business areas of Financial Services (Banking, Assurance and Financial Approval). Thereby the application of the CPW Method can take place in a technical system.

9. The application of the CPW Method to data and information in the business area Chemistry. Thereby the application of the CPW Method can take place in a technical system.

10. The application of the CPW Method to data and information in the business area Pharmacy. Thereby the application of the CPW Method can take place in a technical system.

11. The application of the CPW Method to data and information in the business area Medicine. Thereby the application-of the CPW Method can take place in a technical system.

12. The application of the CPW Method to data and information in the business area Transport. Thereby the application of the CPW Method can take place in a technical system.

13. The application of the CPW Method to data and information in the business area Travel. Thereby the application of the CPW Method can take place in a technical system.

14. The application of the CPW Method to data and information in the business area Film Industry. Thereby the application of the CPW Method can take place in a technical system.

15. The application of the CPW Method to data and Information in the business area Politics. Thereby the application of the CPW Method can take place in a technical system.

16. The application of the CPW Method to data and information in the business area Psychology. Thereby the application of the CPW Method can take place in a technical system.

17. The application of the CPW Method to data and information in the area Legal Practice, Jurisprudence and Judiciary. Thereby the application of the CPW Method can take place in a technical system.

18. The application of the CPW Method to data and information in various areas, in particular:
(a) CRM Customer Relationship Management
(b) ERP Enterprise Resource Planning
(c) SCM Supply Chain Management
(d) E-Business Integration
Thereby the application of the CPW Method can take place in a technical system.
